(19) United States
(12) Patent Application Publication
(10) Pub. No.: US 2020/0244875 A1
(43) Pub. Date: Jul. 30, 2020

(54) ELECTRONIC DEVICE AND METHOD FOR PROCESSING LINE DATA INCLUDED IN IMAGE FRAME DATA INTO MULTIPLE INTERVALS

(71) Applicant: Samsung Electronics Co., Ltd., Gyeonggi-do (KR)

(72) Inventors: Yonggu LEE, Gyeonggi-do (KR); Minkyu PARK, Gyeonggi-do (KR); Kihuk LEE, Gyeonggi-do (KR); Joonseok KIM, Gyeonggi-do (KR)

(73) Assignee: Samsung Electronics Co., Ltd.

(21) Appl. No.: 16/776,996

(22) Filed: Jan. 30, 2020

(30) Foreign Application Priority Data
Jan. 30, 2019 (KR) 10-2019-0012067

(51) Int. Cl. H04N 5/232

(52) U.S. Cl. CPC H04N 5/23229

(57) ABSTRACT

An electronic device is provided for processing line data. The electronic device includes a plurality of photo diodes disposed based on a plurality of lines; a buffer configured to at least part of image frame data acquired at the photo diodes; and a processor configured to acquire an image based on first image data acquired by processing first partial data stored in the buffer using a first image signal processor (ISP) and second image data acquired by processing second partial data stored in the buffer using a second ISP, wherein the first partial data and the second partial data correspond to a first interval and a second interval, respectively, which are distinguished in the lines.

### CROSS-REFERENCE TO RELATED APPLICATION(S)

This application is based on and claims priority under 35 U.S.C. § 119 to Korean Patent Application No. 10-2019-0012067, filed on Jan. 30, 2019, in the Korean Intellectual Property Office, the entire disclosure of which is incorporated herein by reference.

### BACKGROUND

### 1. Field

The disclosure relates generally to an electronic device and a method for processing frame data obtained from an image sensor.

### 2. Description of Related Art

With recent advances in digital technology, various methods for processing a digital image are being developed. Representative electronic devices for processing the digital image may include digital cameras, smart phones, tablet personal computers (PCs), etc.

An electronic device may include a camera module and an image signal processor. The camera module may convert an optical signal input through a lens to image data, and the image signal processor may display the image data as a preview image and process and store the image data as moving image data or still image data.

The electronic device may process the image on a frame data basis. An operating frequency of an image signal processor (ISP) for processing the frame data may correspond to a clock (e.g., a pixel clock P_{CLK}) of the frame data or an image sensor. Accordingly, if the ISP processes the frame data of a relatively high frame per second (FPS) or a large size, the operating frequency of the ISP increases and power consumption of the ISP may exponentially increase.

### SUMMARY

The disclosure has been made to address the above-mentioned problems and disadvantages, and to provide at least the advantages described below.

In accordance with an aspect of the disclosure, an electronic device is provided, which includes an image sensor; an image sensor module including a line buffer configured to store image frame data obtained from the image sensor, on a line basis; a distribution module including a plurality of line buffers and configured to: while obtaining the image frame data using the image sensor, obtain line data that is part of the image frame data stored in the line buffer, and transmit first partial data corresponding to a first designated interval of the line data, and second partial data corresponding to a second designated interval of the line data; a first image processing module configured to perform image processing for the first partial data transmitted from the distribution module; a second image processing module configured to perform image processing for the second partial data transmitted from the distribution module; a merging module configured to generate merged line data by merging the first partial data processed at the first image processing module and the second partial data processed at the second image processing module; and a memory module configured to store the merged line data sequentially output from the merging module as frame data corresponding to the image frame data.

In accordance with another aspect of the disclosure, an electronic device is provided, which includes a plurality of photo diodes disposed based on a plurality of lines; a buffer configured to at least part of image frame data acquired at the photo diodes; and a processor configured to acquire an image based on first image data acquired by processing first partial data stored in the buffer using a first image signal processor (ISP) and second image data acquired by processing second partial data stored in the buffer using a second ISP, wherein the first partial data and the second partial data correspond to a first interval and a second interval, respectively, which are distinguished in the lines.

In accordance with another aspect of the disclosure, an electronic device is provided, which includes an image sensor including a plurality of photo diodes disposed based on a plurality of lines; and a processor operatively coupled with the image sensor. The processor is configured to: store a part, corresponding to a first line of the lines, of image frame data obtained from the photo diodes, segment a part of the stored image frame data into a plurality of partial data corresponding to a plurality of intervals of the first line, the intervals being defined by distributing photo diodes of the first line of the photo diodes, perform image processing on the partial data, and acquire image frame data that is processed by merging the partial data processed based on the intervals.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an electronic device in a network environment according to an embodiment;

FIG. 2 illustrates a camera module according to an embodiment;

FIG. 3 illustrates an electronic device for processing image frame data of an image sensor according to an embodiment;

FIG. 4 is a flowchart illustrating operations of an electronic device according to an embodiment;

FIG. 5 illustrates a plurality of photo diodes disposed in an image sensor of an electronic device according to an embodiment;

FIG. 6 is a flowchart illustrating operations for providing data stored in a line buffer to a plurality of ISPs in an electronic device according to an embodiment;

FIG. 7 illustrates providing line data stored in a line buffer to a plurality of buffers based on a distribution module in an electronic device according to an embodiment;

FIG. 8 illustrates applying a designated delay to line data distributed to a plurality of buffers based on a distribution module in an electronic device according to an embodiment;

FIG. 9A illustrates segmenting frame data based on a distribution module in an electronic device according to an embodiment;

FIG. 9B illustrates segmenting frame data based on a distribution module in an electronic device according to an embodiment;

FIG. 10 is a flowchart illustrating operations of ISPs in an electronic device according to an embodiment;

FIG. 11 illustrates a timing diagram of clocks used in different hardware components of an electronic device according to an embodiment;

FIG. 12 is a flowchart illustrating operations for storing image frame data based on a merging module and a storing module in an electronic device according to an embodiment;

FIG. 13 illustrates processing frame data of an electronic device at a line buffer and a storing module according to an embodiment;

FIG. 14 illustrates storing image frame data in a memory of an electronic device according to an embodiment;

FIG. 15 illustrates processing image frame data based on three ISPs in an electronic device according to an embodiment;

FIG. 16 illustrates an electronic device according to an embodiment; and

FIG. 17 illustrates processing frame data in an electronic device according to an embodiment.

### DETAILED DESCRIPTION

Various embodiments of the disclosure are described below with reference to the accompanying drawings. However, the embodiments described herein are not intended to limit the disclosure to any specific embodiments, and the disclosure should be understood to include various modifications, equivalents and/or alternatives of the embodiments of the disclosure described herein.

In describing the accompanying drawings, similar reference numerals may be used to designate similar elements.

The terms and expressions used in the disclosure are used merely to describe certain embodiments, and are not intended to limit the scope of other embodiments. The expression of the singular form may include the expression of the plural form, unless otherwise dictating clearly in context. The terms used herein, including technological or scientific terms, have the same meaning as those commonly understood by a person of ordinary skill in the art to which the disclosure pertains. Among the terms used in the disclosure, the terms defined in a general dictionary may be interpreted as having meanings consistent with their meanings in the context of the related technology, and are not to be interpreted in an ideal or excessively formal manner, unless defined clearly in the disclosure. In some cases, terms defined in the disclosure should not be interpreted to exclude embodiments of the disclosure.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

The expressions “have”, “may have”, “comprise”, and “may comprise”, etc., indicate the existence of a corresponding feature (e.g., a numeral value, a function, an operation, or a constituent element such as a component, etc.), and do not exclude the existence of an additional feature.

The expressions “A or B”, “at least one of A or/and B”, and “one or more of A or/and B”, etc., may include all available combinations of items enumerated together. For example, “A or B”, “at least one of A and B”, and “at least one of A or B” may denote all cases of (1) including at least one A, (2) including at least one B, or (3) including at least one A and at least one B.

The expressions “1st”, “2nd”, “first” or “second”, etc., may modify various elements irrespective of order and/or importance, and are merely used to distinguish one element from another element and are not intended to limit the corresponding elements. For example, a first user device and a second user device may represent different user devices, regardless of order or importance. A first element may be referred to as a second element without departing from the scope of the disclosure. Likewise, a second element may be referred to as a first element.

When an element (e.g., a first element) is described as being (operatively or communicatively) “coupled” or “connected” with/to another element (e.g., a second element), the first element may be directly coupled to the second element or may be coupled to the second element through a third element. However, when an element (e.g., a first element) is described as being “directly coupled” or “directly connected” with/to another element (e.g., a second element), a third element does not exist between the first element and the second element.

The expression “configured (or set) to” used in the disclosure may be used interchangeably with, for example, “suitable for”, “having the capacity to”, “designed to”, “adapted to”, “made to”, or “capable of” in based on the circumstances. The term “configured (or set) to” may not necessarily mean only “specifically designed to” in hardware. Instead, in some circumstances, the expression “device configured to” may mean that the device is “capable of” together with other devices or components. For example, the phrase “processor configured (or set) to perform A, B, and C” may mean an exclusive processor (e.g., an, embedded processor) for performing a corresponding operation, or a generic-purpose processor (e.g., a central processing unit (CPU) or an application processor (AP)) executing one or more software programs stored in a memory device, thereby being capable of performing corresponding operations.

An electronic device according to an embodiment of the disclosure may include a smart phone, a tablet PC, a mobile phone, a video phone, an electronic book (e-book) reader, a desktop PC, a laptop PC, a netbook computer, a workstation, a server, a personal digital assistant (PDA), a portable multimedia player (PMP), a moving picture experts group (MPEG-1 or MPEG-2) audio layer 3 (MP3) player, a mobile medical instrument, a camera, or a wearable device. According to various embodiments, the wearable device may include at least one of an accessary type (e.g., a watch, a ring, a wristlet, an anklet, a necklace, glasses, a contact lens, or a head-mounted-device (HMD), etc.), a fabric or clothing integrated type (e.g., electronic clothes), a body mount type (e.g., a skin pad or tattoo), or a bio-physical implantation type (e.g., an implantable circuit).

An electronic device may be a home appliance, such as a television (TV), a digital versatile disk (DVD) player, an audio system, a refrigerator, an air conditioner, a cleaner, an oven, a microwave, a washing machine, an air cleaner, a set-top box, a home automation control panel, a security control panel, a TV box (e.g., Samsung HomeSync™, Apple TV™, or Google TV™), a game console (e.g., Xbox™, Play Station™), an electronic dictionary, an electronic locking system, a camcorder, or an electronic frame.

An electronic device may include various medical instruments (e.g., various portable medical measurement instruments (i.e., a blood sugar measuring instrument, a heat rate measuring instrument, a blood pressure measurement instrument, or a body temperature measurement instrument, etc.), magnetic resonance angiography (MRA) machine, magnetic resonance imaging (MRI) machine, computerized tomography (CT) machine, a photographing machine, or an ultrasonic machine, etc.), a navigation device, a global navigation satellite system (GNSS), an event data recorder (EDR), a flight data recorder (FDR), a car infotainment device, an electronic equipment for a ship (e.g., a navigation device for ship, a gyrocompass, etc.), avionics, a security instrument, a head unit for a car, an industrial or home robot, an automatic teller's machine (ATM), a point of sales (POS) machine, or an Internet of things (IoT) device (e.g., an electric light bulb, various sensors, an electricity or gas meter, a sprinkler device, a fire alarm, a thermostat, a streetlight, a toaster, an exercise device, a hot water tank, a heater, a boiler, etc.).

An electronic device may include at least one of a part of furniture or building/structure, an electronic board, an electronic signature receiving device, a projector, or various metering instruments (e.g., tap water, electricity, gas, or a radio wave metering instrument, etc.). The electronic device may be one of the aforementioned various devices or a combination of the devices. The electronic device may be a flexible electronic device or a foldable electronic device.

However, an electronic device is not limited to the aforementioned devices, and may include a new electronic device based on technological developments.

The term ‘user’ may denote a person who uses the electronic device or a device (e.g., an artificial-intelligence electronic device) that uses the electronic device.

For convenience of explanation, components may be exaggerated or reduced in size. For example, the size and the thickness of each component shown in the drawings are arbitrarily shown for convenience of explanation, and thus the disclosure is not necessarily limited to those shown in the drawings.

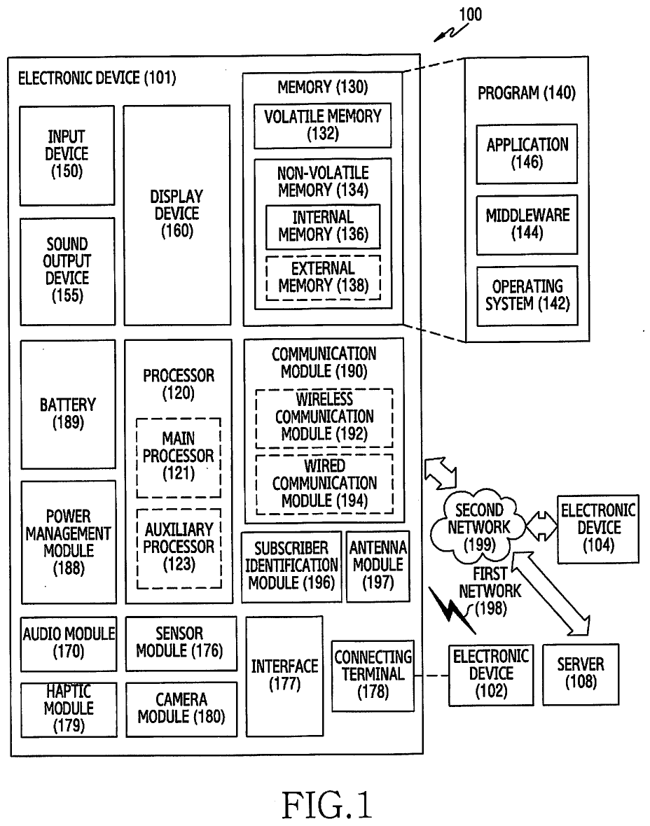

FIG. 1 illustrates an electronic device 101 in a network environment 100 according to an embodiment.

Referring to FIG. 1, the electronic device 101 may communicate with an electronic device 102 via a first network 198 (e.g., a short-range wireless communication network), or an electronic device 104 or a server 108 via a second network 199 (e.g., a long-range wireless communication network). The electronic device 101 may communicate with the electronic device 104 via the server 108. The electronic device 101 includes a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, and an antenna module 197. Alternatively, at least one (e.g., the display device 160 or the camera module 180) of the components may be omitted from the electronic device 101, or one or more other components may be added in the electronic device 101. Some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute software (e.g., a program 140) to control at least one other component (e.g., a hardware or software component) of the electronic device 101 coupled with the processor 120, and may perform various data processing or computation. As at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. The processor 120 may include a main processor 121 (e.g., a CPU or an AP), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). The auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include software (e.g., the program 140) and input data or output data for a command related thereto. The memory 130 includes the volatile memory 132 and the non-volatile memory 134.

The program 140 may be stored in the memory 130 as software, and includes, for example, an operating system (OS) 142, middleware 144, and an application 146.

The input device 150 may receive a command or data to be used by other component (e.g., the processor 120) of the electronic device 101, from the outside (e.g., a user) of the electronic device 101. The input device 150 may include a microphone, a mouse, a keyboard, or a digital pen (e.g., a stylus pen).

The sound output device 155 may output sound signals to the outside of the electronic device 101. The sound output device 155 may include a speaker or a receiver. The speaker may be used for general purposes, such as playing multimedia or playing record, and the receiver may be used for an incoming calls. The receiver may be implemented as separate from, or as part of the speaker.

The display device 160 may visually provide information to the outside (e.g., a user) of the electronic device 101. The display device 160 may include a display, a hologram device, or a projector and control circuitry to control a corresponding one of the display, hologram device, and projector. The display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. The audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. The sensor module 176 may include a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. The interface 177 may include a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). The connecting terminal 178 may include an HDMI connector, a USB connector, an SD card connector, and/or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. The haptic module 179 may include, for example, a motor, a piezoelectric element, or an electric stimulator.

The camera module 180 may capture a still image or moving images. The camera module 180 may include one or more lenses, image sensors, image signal processors, or flashes.

The power management module 188 may manage power supplied to the electronic device 101. The power management module 188 may be implemented as at least part of a power management integrated circuit (PMIC).

The battery 189 may supply power to at least one component of the electronic device 101. The battery 189 may include a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the AP) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, Wi-Fi direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. The antenna module 197 may include an antenna including a radiating element composed of a conductive material or a conductive pattern formed in or on a substrate (e.g., PCB). The antenna module 197 may include a plurality of antennas. At least one antenna appropriate for a communication scheme used in the communication network, such as the first network 198 or the second network 199, may be selected by the communication module 190 (e.g., the wireless communication module 192) from the plurality of antennas. The signal or the power may then be transmitted or received between the communication module 190 and the external electronic device via the selected at least one antenna. Another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

Commands or data may be transmitted or received between the electronic device 101 and the external electronic device 104 via the server 108 coupled with the second network 199. Each of the electronic devices 102 and 104 may be a device of a same type as, or a different type, from the electronic device 101. All or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

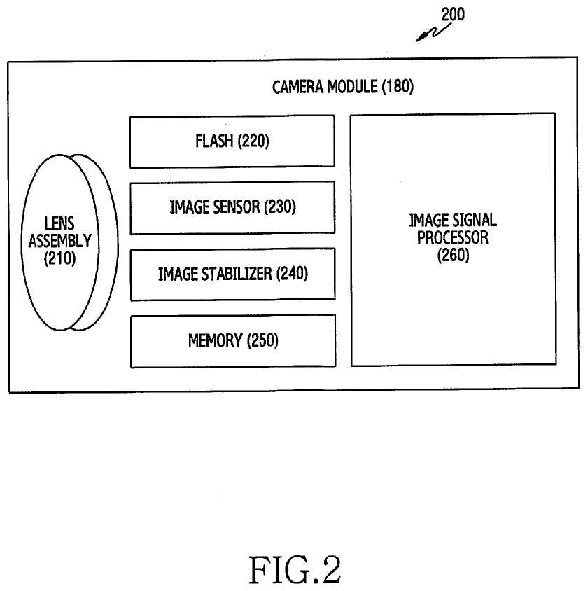

FIG. 2 is a block diagram 200 illustrating the camera module 180 according to an embodiment.

Referring to FIG. 2, the camera module 180 includes a lens assembly 210, a flash 220, an image sensor 230, an image stabilizer 240, memory 250 (e.g., buffer memory), and an image signal processor 260. The lens assembly 210 may collect light emitted or reflected from an object whose image is to be taken. The lens assembly 210 may include one or more lenses. The camera module 180 may include a plurality of lens assemblies 210. In such a case, the camera module 180 may form a dual camera, a 360-degree camera, a spherical camera, etc. Some of the plurality of lens assemblies 210 may have the same lens attribute (e.g., view angle, focal length, auto-focusing, f number, or optical zoom), or at least one lens assembly may have one or more lens attributes different from those of another lens assembly. The lens assembly 210 may include a wide-angle lens or a telephoto lens.

The flash 220 may emit light that is used to reinforce light reflected from an object. The flash 220 may include one or more light emitting diodes (LEDs) (e.g., a red-green-blue (RGB) LED, a white LED, an infrared (IR) LED, or an ultraviolet (UV) LED) or a xenon lamp.

The image sensor 230 may obtain an image corresponding to an object by converting light emitted or reflected from the object and transmitted via the lens assembly 210 into an electrical signal. The image sensor 230 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 230 may be implemented using, for example, a charged coupled device (CCD) sensor or a complementary metal oxide semiconductor (CMOS) sensor.

The image stabilizer 240 may move the image sensor 230 or at least one lens included in the lens assembly 210 in a particular direction, or control an operational attribute (e.g., adjust the read-out timing) of the image sensor 230 in response to the movement of the camera module 180 or an electronic device including the camera module 180. This allows compensating for at least part of a negative effect (e.g., image blurring) by the movement on an image being captured. The image stabilizer 240 may sense such a movement by the camera module 180 or the electronic device using a gyro sensor or an acceleration sensor disposed inside or outside the camera module 180. The image stabilizer 240 may be implemented as an optical image stabilizer.

The memory 250 may store, at least temporarily, at least part of an image obtained via the image sensor 230 for a subsequent image processing task. If image capturing is delayed due to shutter lag or multiple images are quickly captured, a raw image obtained (e.g., a Bayer-patterned image, a high-resolution image) may be stored in the memory 250, and its corresponding copy image (e.g., a low-resolution image) may be previewed via a display device. Thereafter, if a specified condition is met (e.g., by a user's input or system command), at least part of the raw image stored in the memory 250 may be obtained and processed by the image signal processor 260. The memory 250 may be configured as at least part of a memory of the electronic device or as a separate memory that is operated independently from the memory of the electronic device.

The image signal processor 260 may perform one or more image processing with respect to an image obtained via the image sensor 230 or an image stored in the memory 250. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 260 may perform control (e.g., exposure time control or read-out timing control) with respect to at least one of the components (e.g., the image sensor 230) included in the camera module 180. An image processed by the image signal processor 260 may be stored back in the memory 250 for further processing, or may be provided to an external component outside the camera module 180. The image signal processor 260 may be configured as at least part of a processor of the electronic device, e.g., the processor 120, or as a separate processor that is operated independently from the processor. If the image signal processor 260 is configured as a separate processor from the processor, at least one image processed by the image signal processor 260 may be displayed, by the processor of the electronic device, via a display device as it is or after being further processed.

An electronic device may include a plurality of camera modules having different attributes or functions. At least one of the plurality of camera modules may form a wide-angle camera and at least another of the plurality of camera modules may form a telephoto camera. Similarly, at least one of the plurality of camera modules may form a front camera and at least another of the plurality of camera modules may form a rear camera.

Various embodiments as set forth herein may be implemented as software including one or more instructions that are stored in a storage medium that is readable by a machine (e.g., an electronic device). A processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium, wherein the term “non-transitory” simply means that the storage medium is a tangible device, and does not include a signal (e.g., an electromagnetic wave), but does not differentiate between where data is semi-permanently stored in the storage medium and where the data is temporarily stored in the storage medium.

A method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

Each component (e.g., a module or a program) of the above-described components may include a single entity or multiple entities. One or more of the above-described components may be omitted, or one or more other components may be added. Alternatively or additionally, a plurality of components (e.g., modules or programs) may be integrated into a single component. The integrated component may still perform one or more functions of each of the plurality of components in the same or similar manner as they are performed by a corresponding one of the plurality of components before the integration. Operations performed by the module, the program, or another component may be carried out sequentially, in parallel, repeatedly, or heuristically, or one or more of the operations may be executed in a different order or omitted, or one or more other operations may be added.

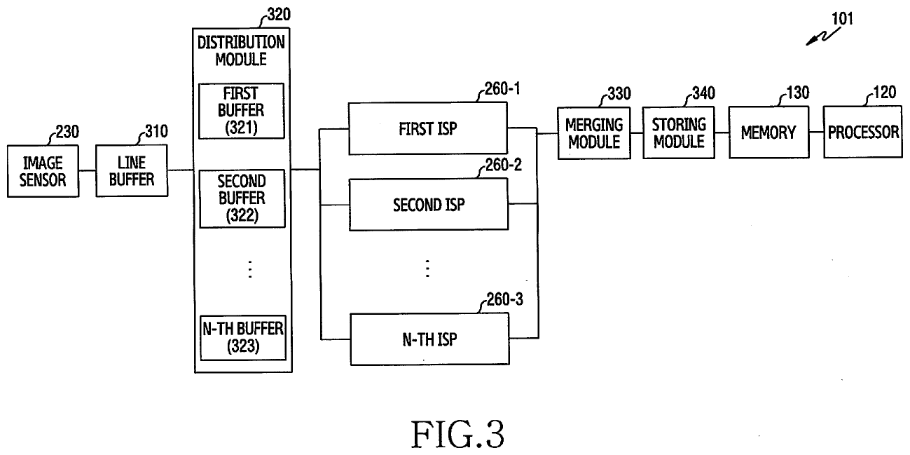

FIG. 3 illustrates an electronic device 101 for processing image frame data of an image sensor 230 according to an embodiment.

Referring to FIG. 3, the electronic device includes an image sensor 230, a line buffer 310, a distribution module 320, a plurality of ISPs 260, a merging module 330, a storing module 340, a memory 130, and a processor 120. The image sensor 230, the line buffer 310, the distribution module 320, one or more ISPs 260, the merging module 330, the storing module 340, the memory 130, and the processor 120 may be operatively coupled by an electrical interface such as a communication bus. The electronic device may acquire an image file or a video file by capturing a subject in an external space.

The image sensor 230 may be included in one or more cameras of the electronic device. If the electronic device includes a plurality of cameras, each camera may be disposed on at least one of a front side or a rear side of the electronic device. The cameras each may include a lens, an actuator, and the image sensor 230. The image sensor 230 may include pixels arranged in two dimensions. The image sensor 230 may convert an image formed via the lens to an electric signal of pixels based on a photoelectric effect.

The pixels each may include a plurality of photo diodes (PDs). The PDs may change an optical signal to an electric signal based on the photoelectric effect. Output signals of the PDs may include the electric signal converted from the optical signal.

The image sensor 230 may obtain the output signals of the PDs at a designated time or in a designated time interval. An output signal of the image sensor 230 may include the output signals of the PDs obtained at the designated time or in the designated time interval. The image sensor 230 may output the output signals of the PDs to outside, based on the sequence of the pixels including the PDs.

The image sensor 230 may output the output signals of all the PDs of any one of the pixels on every designated clock (e.g., a pixel clock P_{CLK}). Pixel data is the output signal of the image sensor 230, and indicates data including the output signals of the whole PDs of any one of the pixels. In an embodiment, a pixel data output order of the image sensor 230 may correspond to the sequence of the pixels in the image sensor 230. The image sensor 230 may output the pixel data in a progressive manner.

Frame data is the output signal of the image sensor 230, and indicates data including the output signals of each PD at a specific time or in a designated time interval. The frame data may include pixel data related to at least part of the pixels of the image sensor 230. In the frame data, a pixel data order may be related to the sequence of the pixels in the image sensor 230. Outputting the frame data at the image sensor 230 may indicate outputting the pixel data of the whole pixels according to a plurality of clocks (e.g., the pixel clocks P_{CLK} corresponding to the number of the PDs of the image sensor 230).

The line buffer 310 may include a memory for at least temporarily storing the frame data obtained from the image sensor 230 on a line basis. The line buffer 310 may operatively couple with the image sensor 230. The image sensor 230 may output the frame data to the line buffer 310. The line buffer 310 may store at least part of the frame data and then output at least part of the stored frame data on every designated clock (e.g., a horizontal sync signal or a horizontal sync clock H_{SYNC}).

At least part of the frame data stored in the line buffer 310 may be related to the pixels arranged in the two dimensions of the image sensor 230. The PDs may be disposed in the image sensor 230 based on the pixels disposed in the two dimensions along two orthogonal axes (e.g., a horizontal axis and a vertical axis). A line is a group of pixels disposed in the image sensor 230, and may correspond to the group of the pixels disposed along one (e.g., the horizontal axis) of the two axes. If A pixels (where A is an integer greater than or equal to 2) are disposed on the horizontal axis, B pixels (where B is an integer greater than or equal to 2) are disposed on the vertical axis, and A×B (e.g., 4096×4096) pixels are disposed in total, one line may correspond to a group of the A pixels on the horizontal axis. The line data is at least part of the frame data and indicates frame data corresponding to one of the lines.

The image sensor 230 may sequentially output pixel data of the A pixels of a first line of the lines, and then sequentially output pixel data of the A pixels of a second line which is next to the first line. The line buffer 310 may store the pixel data of the whole pixels of any one of the lines. The line buffer 310 may store at least one line data. A sequence of the pixel data stored in the line buffer 310 may correspond to the sequence of the pixels disposed in the line.

The distribution module 320 may include a plurality of buffers (a first buffer 321, a second buffer 322, . . . , and an N-th buffer 323 of FIG. 3) for storing at least part of the pixel data stored in the line buffer 310. The buffers each may store pixel data of intervals which are distinguished in the line. A size or the number of the buffers may be related to at least one of system stabilities.

While obtaining the frame data using the image sensor 230, the distribution module 320 may sequentially acquire line data included as part of the frame data at least temporarily stored in the line buffer 310, according to a plurality of designated intervals. The distribution module 320 may at least temporarily store at least part of the acquired line data in at least one of the buffers.

If the A pixels of the line are segmented to N intervals (where N is an integer greater than or equal to 2) in a designated number, the distribution module 320 may store pixel data of pixels included in the N intervals, in the first buffer 321 through the N-th buffer 323 respectively. The first buffer 321 through the N-th buffer 323 may store the pixel data corresponding to A/N pixels respectively. The distribution module 320 may extract the pixel data corresponding to the A/N pixels from the line data stored in the line buffer 310 on every designated clock (e.g., a horizontal sync signal or a horizontal sync clock H_{SYNC}), and then store the extracted pixel data in one of the first buffer 321 through the N-th buffer 323. The distribution module 320 may store the pixel data in the first buffer 321 through the N-th buffer 323 based on a designated delay. The delay may be related to the pixel data size stored in the first buffer 321 through the N-th buffer 323.

Referring to FIG. 3, the electronic device 101 includes a plurality of ISPs (a first ISP 260-1, a second ISP 260-2, . . . , and an N-th ISP 260-3). The ISPs each may correspond to the ISP 260 of FIG. 2. The number of the ISPs of the electronic device 101 may correspond to the number of the buffers of the distribution module 320. The ISPs each may be operatively coupled with the buffers of the distribution module 320.

The ISPs each may process the pixel data stored in the corresponding buffer. Since the line data is segmented to the N intervals and stored in the first buffer 321 through the N-th buffer 323, the ISPs may process the pixel data stored in the N intervals, respectively. The image processing of the ISPs may include color interpolation (CI), gamma correction, edge enhancement (EE), noise reduction (NR), etc.

The merging module 330 may be connected to some or all of the ISPs. The merging module 330 may merge the pixel data processed by the ISPs based on the intervals of the line. Each of the ISPs may forward result of the image processing using the pixel data to the merging module 330. The merging module 330 may merge the received result, based on the intervals corresponding to the ISPs in the line. As the merging module 330 merges the result received from the ISPs, frame data corresponding to the image frame data acquired at the image sensor 230 may be generated.

The storing module 340 may store the frame data merged by the merging module 330 in the memory 130. If the merging module 330 outputs the resulting data merged on the line basis, the storing module 340 may store the merged resulting data as part of the frame data. The storing module 340 may store the frame data received from the merging module 340, in a designated area of the memory 130.

The processor 120 may identify the frame data stored in the memory 130. The processor 120 may process the identified frame data, based on a running application. For example, the processor 120 may create an image file or a video file of a designated format (e.g., joint photographic experts group (JPEG) format or MPEG format) based on the identified frame data.

The distribution module 320, the merging module 330, and the storing module 340 may be hardware components in a camera module, the electronic device 101, or at least one of the ISPs. For example, at least one of the distribution module 320, the merging module 330, or the storing module 340 may be included in an IC coupled with the ISPs.

The processor 120 may generate a control signal for controlling the image sensor 230, based on the user of the electronic device 101 or an application running in the electronic device 120. The image sensor 230 may output the frame data based on the control signal. If the user touches a particular visual element (a shutter button outputted on the display) of the electronic device 101, presses a designated physical button, or executes a designated application (e.g., a camera application), the processor 120 may generate the control signal.

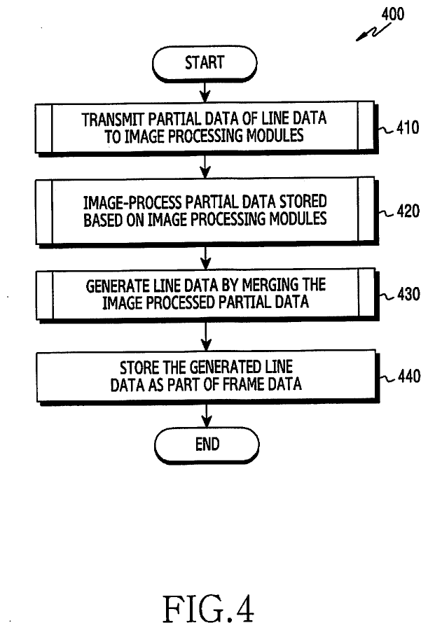

FIG. 4 illustrates a flowchart 400 of operations of an electronic device according to an embodiment. The electronic device of FIG. 4 may correspond to the electronic device 101 or FIG. 1 or FIG. 3.

Referring to FIG. 4, in step 410, the electronic device transmits a plurality of partial data of line data to a plurality of image processing modules. The electronic device may transmit first partial data corresponding to a first designated interval of the line data to one of the image processing modules, and transmit second partial data corresponding to a second designated interval to another one of the image processing modules.

The electronic device may distribute the line data to a plurality of buffers based on a plurality of designated intervals. Pixels of the image sensor of the electronic device may be divided into a plurality of intervals in the line. Some of the intervals may overlap in the line. The buffers may store part of the line data related to the corresponding interval of the frame data.

In step 420, the electronic device performs image processing for the partial data stored in the line buffers, based on the ISPs corresponding to the line buffers, respectively. If the electronic device includes the image processing modules or the ISPs, the image processing modules may perform image processing using the partial data obtained from the distribution module. If the electronic device includes two ISPs, the first ISP may obtain first partial data corresponding to the first interval of the frame data. The first partial data may include the pixel data of the first interval of one or more line data. The first ISP may perform the image processing related to the obtained first partial data. The second ISP may obtain second partial data corresponding to the second interval of the frame data. The second partial data may include the pixel data of the second interval of one or more line data. The second ISP may perform the image processing related to the obtained second partial data. The first interval and the second interval may not overlap in the line.

In step 430, the electronic device generates line data by merging the image processed resulting data. The electronic device may merge the pixel data of the first interval processed by the first ISP and the pixel data of the second interval processed by the second ISP.

In step 440, the electronic device stores the generated line data as part of the frame data. The electronic device may store the pixel data processed by the ISPs in the memory.

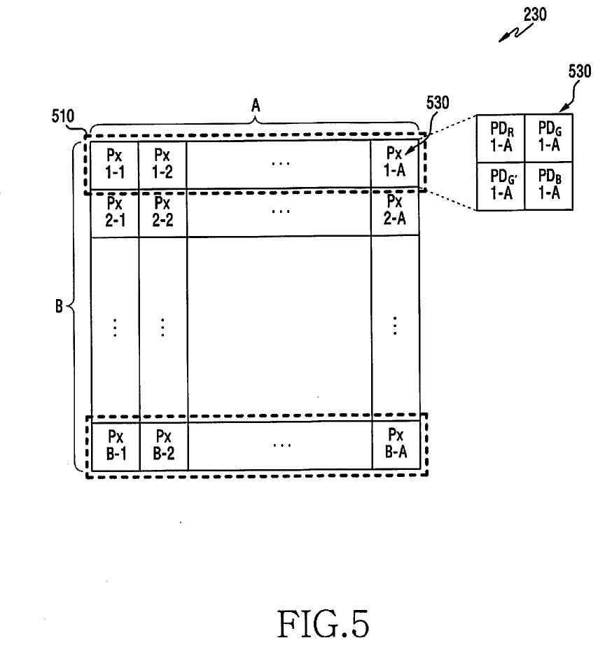

FIG. 5 illustrates a diagram of a plurality of photo diodes disposed in an image sensor 230 of an electronic device according to an embodiment. The electronic device of FIG. 5 may correspond to the electronic device 101 or FIG. 1 or FIG. 3. An image sensor 230 of FIG. 5 may correspond to the image sensor 230 or FIG. 2 or FIG. 3.

Referring to FIG. 5, the pixels in the image sensor are arranged based on two dimensions. A×B pixels may be arranged along horizontal lines or vertical lines related to the horizontal axis or the vertical axis respectively. A and B are natural numbers. The pixels may be arranged along A horizontal axis or B vertical axis. Px m-n indicates a pixel at an intersection of an m-th horizontal line and an n-th vertical line.

The pixels may include one or more PDs. A plurality of PDs of one (Px 1-A 530) of the pixels is disposed. Each of the pixels may include the PDs disposed based on the Bayer pattern. A PD (PD_{R} 1-A) of a red wavelength band, two PDs (PD_{G} 1-A and PD_{G}′ 1-A) of a green wavelength band, and a PD (PD_{B} 1-A) of a blue wavelength band may be disposed in one (Px 1-A 530) of the pixels based on the Bayer pattern. The PDs in each pixel may be disposed differently from the Bayer pattern.

Pixel data corresponding to one of the pixels (Px 1-A 530) may include output signals of the PDs of the pixel Px 1-A 530. The image sensor may output the output signals of the PDs based on the sequence of the pixels. The pixel data output order of the image sensor may be based on at least one of the horizontal line or the vertical line. For example, the image sensor may output pixel data of A pixels of a first horizontal line 510, and then output pixel data of A pixels of a second horizontal line which is next to the first horizontal line 510. Based on the sequence of the A pixels of the first horizontal line 510, the image sensor may output the pixel data of the A pixels of the first horizontal line 510.

If the image sensor outputs pixel data corresponding to a pixel Px 1-1 on a first pixel clock, the image sensor may output pixel data corresponding to a pixel Px 1-2 at a second pixel clock which is next to the first pixel clock. The image sensor may output pixel data corresponding to a pixel Px 1-A on a pixel clock A. The image sensor may output pixel data corresponding to a pixel Px B-A of a B horizontal line 520 on a pixel clock A×B. The image sensor may output pixel data corresponding to one of the pixels to a line buffer on every designated clock (the pixel clock). The line buffer may accumulate the pixel data received from the image sensor on every designated clock.

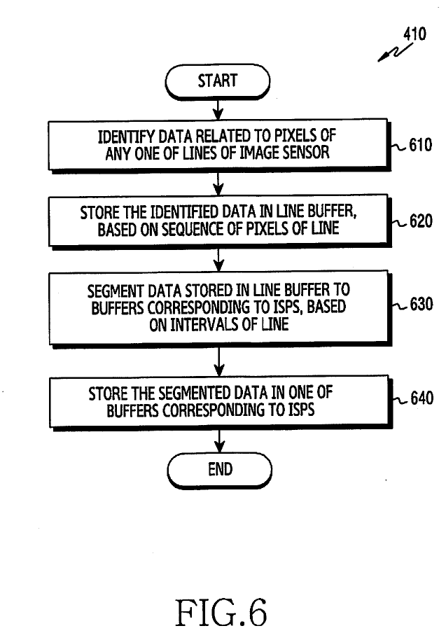

FIG. 6 illustrates a flowchart 410 of operations for providing data stored in a line buffer to a plurality of ISPs in an electronic device according to an embodiment. The electronic device of FIG. 6 may correspond to the electronic device 101 or FIG. 1 or FIG. 3. The line buffer of FIG. 6 may correspond to the line buffer 310 of FIG. 3. The ISPs of FIG. 6 may correspond to the ISPs (the first ISP 260-1 through the N-th ISP 260-3) of FIG. 3. At least some of operations of FIG. 6 may be related to operation 410 of FIG. 4. Operations of FIG. 6 may be fulfilled by the distribution module 320 of FIG. 3.

Referring to FIG. 6, in step 610, the electronic device identifies data related to pixels of any one of lines of an image sensor. The electronic device may identify pixel data related to one or more pixels of the line buffer. The electronic device may identify the pixel data outputted from the image sensor at designated intervals or on every designated first clock (e.g., the pixel clock P_{CLK}). A sequence of the pixel data outputted from the image sensor on every first clock may correspond to the sequence of the pixels of one of the lines of the image sensor.

In step 620, the electronic device stores the identified data in the line buffer, based on the sequence of the pixels of the line. The line buffer may store the pixel data of the whole pixels of one of horizontal lines of the image sensor. The order for storing the pixel data in the line buffer may correspond to the sequence of the pixels of one of the horizontal lines. Steps 610 and 620 may be conducted based on the first clock. For example, the electronic device may store the pixel data outputted from the image data, in the line buffer on every first clock.

In step 630, the electronic device segments the data stored in the line buffer to a plurality of buffers corresponding to the ISPs based on a plurality of intervals of the line. The intervals of the line may be defined by segmenting the line of the image sensor by a designated length. The intervals of the line may be defined to overlap at least in part in the line of the image sensor. The electronic device may segment the pixel data stored in the line buffer, based on the intervals.

In step 640, the electronic device stores the segmented data in one of the buffers corresponding to the ISPs respectively. The segmented data may be stored in the buffer relating to the interval corresponding to the segmented data, among the buffers. Steps 630 and 640 may be performed on designated cycles. For example, the electronic device may segment the pixel data stored in the line buffer to the buffers, based on a designated second clock (e.g., a horizontal sync clock H_{SYNC}). The second clock may be longer in cycle than the first clock related to steps 610 and 620. The second clock may be related to the cycle of outputting the horizontal line in the image sensor.

If segmenting the data stored in the line buffer based on the plurality of the intervals, the electronic device may segment the data stored in the line buffer based on a delay which is set according to the intervals. For example, if the data stored in the line buffer is segmented based on a first interval of the horizontal line and a second interval which is next to the first interval, the electronic device may delay the second interval of the line data by a time interval corresponding to the size of the first interval of the line data, and store the data in one of the line buffers.

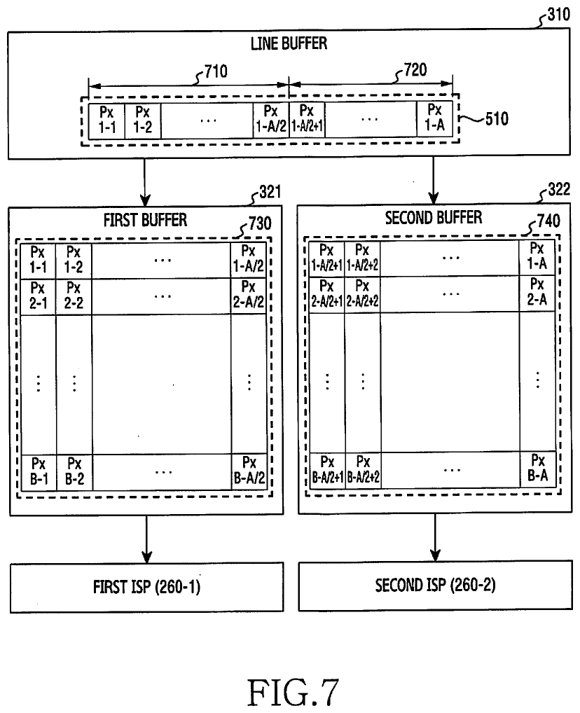

FIG. 7 illustrates providing line data stored in a line buffer to a plurality of buffers based on a distribution module in an electronic device according to an embodiment.

Referring to FIG. 7, the electronic device may identify pixel data of one of pixels from the image sensor on every first clock (e.g., pixel clock P_{CLK}). The electronic device may store the identified pixel data in the line buffer 310. The order of storing the pixel data in the line buffer 310 may correspond to the sequence of the pixels arranged in a horizontal line. In FIG. 7, it is assumed that pixel data of the A pixels (where A is an integer greater than or equal to 2) of the first horizontal line 510, among the pixels of the image sensor, are stored in the line buffer 310.

The electronic device may segment the pixel data stored in the line buffer 310, to the buffers. The first buffer 321 and the second buffer 322 are electrically connected with the line buffer 310. The electronic device may segment the pixel data stored in the line buffer 310 to the first buffer 321 or the second buffer 322. The electronic device may segment the pixel data stored in the line buffer 310, to the first buffer 321 or the second buffer 322 on every second clock (e.g., the horizontal sync clock H_{SYNC}), which is distinguished from the first clock.

The electronic device may segment the pixel data stored in the line buffer 310, based on a plurality of intervals (e.g., a first interval 710 and a second interval 720) of the first horizontal line 510. The first interval 710 and the second interval 720 may be set by dividing the first horizontal line 510 of the image sensor by a designated length. In A pixels of the first horizontal line 510, the first interval 710 may include first A/2 pixels Px 1-1 through Px 1-A/2 and the second interval 720 may include the rest A/2 pixels Px 1-A/2+1 through Px 1-A. Alternatively, the first interval 710 and the second interval 720 may be set to overlap at least in part in the first horizontal line 510. The number of the intervals in the first horizontal line 510 may be proportional to the number of the buffers of the electronic device.

The first buffer 321 may at least temporarily store first data received via first PDs (e.g., PDs in the A/2 pixels of the first interval 710) of PDs of the image sensor. The second buffer 322 may at least temporarily store second data received via at least part of second PDs which are disposed next to the first PDs in the first horizontal line 510. The second buffer 322 may store the second data received via PDs of the A/2 pixels of the second interval 720, which are disposed next to the first PDs.

The pixel data of the first interval 710 and the second interval 720 in all the lines of frame data acquired at the image sensor may be stored in the first buffer 321 and the second buffer 322 respectively. First partial data 730 stored in the first buffer 321 may include the pixel data of the first interval 710 in all the lines of the frame data. Second partial data 740 stored in the second buffer 322 may include the pixel data of the second interval 720 in all the lines of the frame data.

Sizes of the first buffer 321 and the second buffer 322 may be related to system stability of the image processing. The first ISP 260-1 and the second ISP 260-2 may acquire a particular frequency component from the line data distributed to the first buffer 321 and the second buffer 322, based on an infinite impulse response (IIR) filter. For example, only the frequency component of the green wavelength band of RGB sensor information may be selectively identified. The identified frequency component may be a frequency component of a relatively high frequency band. The identified frequency component may be used for auto focus related to a particular position of the frame data. For example, the electronic device may move a focus of an image from the image sensor and a lens position to an optical axis direction which interconnects a subject and the image sensor. The electronic device may acquire IIR filter information according to the lens which moves in the optical axis direction. The electronic device may set a position of the highest IIR filter value, to the focused position.

The IIR filter may be applied to a data group (tab) of the vertical direction (vertical to the line direction) of the stored line data. The first buffer 321 and the second buffer 322 may store at least part of the line data of the lines respectively. The number of the lines required for the IIR filter operation may be related to the sizes of the first buffer 321 and the second buffer 322 or the system stability.

The electronic device may forward at least part of the first partial data 730 stored in the first buffer 321, to the first ISP 260-1. The electronic device may forward at least part of the second partial data 740 stored in the second buffer 322, to the second ISP 260-2. The first ISP 260-1 and the second ISP 260-2 may perform the image processing of the first partial data 730 and the second partial data 740 respectively.

The electronic device may segment the pixel data of the line buffer 310 to the first buffer 321 or the second buffer 322 based on a designated delay.

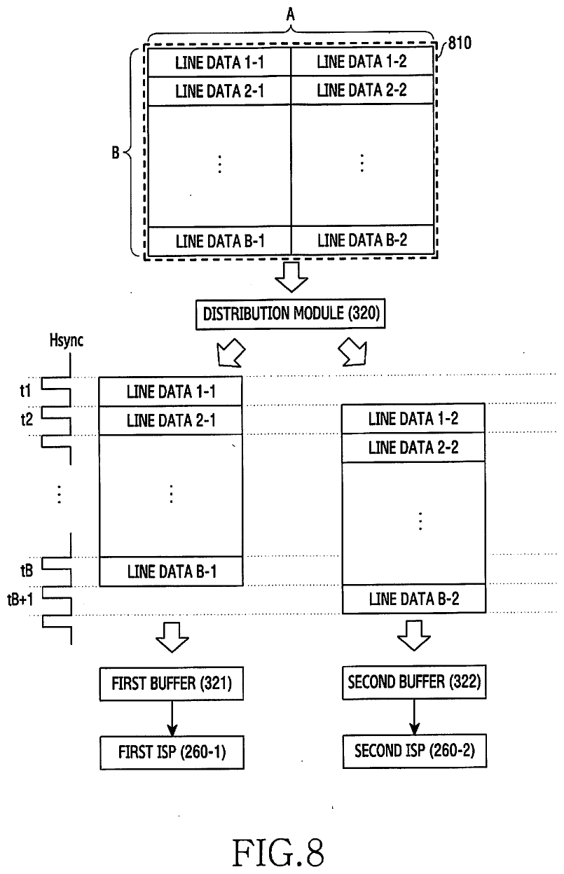

FIG. 8 illustrates applying a designated delay to line data distributed to a plurality of buffers based on a distribution module in an electronic device according to an embodiment.

Referring to FIG. 8, an image sensor of the electronic device outputs frame data 810. Pixels of the image sensor may be arranged based on lines in the frame data 810. For example, if the image sensor includes A×B pixels in total (where A and B are integers greater than or equal to 2), pixel data corresponding to the pixels may be arranged along B lines including A pixels in the frame data 810.

If the electronic device includes two ISPs (the first ISP 260-1 and the second ISP 260-2), the electronic device may segment the frame data 810 according to two designated intervals corresponding to the two ISPs respectively, based on a distribution module 320. The intervals may be set in the line of the image sensor.

In FIG. 8, line data m-n indicates pixel data corresponding to pixels of an n-th interval of an m-th line. The electronic device may segment arbitrary line data m-n from the frame data 810 on every designated clock (e.g., the horizontal sync clock H_{SYNC}). The electronic device may store the segmented line data m-n in the buffers (e.g., the first buffer 321 and the second buffer 322) related to the ISP corresponding to the n-th interval on every clock.

The electronic device transmits the arbitrary line data m-n to the first buffer 321 and the second buffer 322 based on a designated clock. The designated clock may correspond to the horizontal sync clock H_{SYNC}. The electronic device may store the line data in at least one of the first buffer 321 or the second buffer 322, on every horizontal sync clock. If the electronic device stores the line data in both of the first buffer 321 and the second buffer 322 on every horizontal sync clock, the line data stored in the first buffer 321 and the second buffer 322 in the same horizontal sync clock may be related to a specific line of the image sensor or different lines. For example, based on the designated delay corresponding to the intervals, the electronic device may store, in one of the buffers, the line data of the different line from the line data stored in other buffer.

The electronic device may delay line data k-2 corresponding to the second interval by a designated time interval from line data k-1 corresponding to the first interval and transmit the delayed line data k-2 to the second ISP 260-2. The time at which the second ISP 260-2 receives the line data k-2 may be delayed by the designated time interval from the time at which the first ISP 260-1 receives the line data k-1. The designated time interval may correspond to the size of the first interval.

The line data k-1 and the line data k-2 related to an arbitrary k-th line may be stored in the first buffer 321 and the second buffer 322 at different times according to the designated clock. In different time intervals t1 and t2 distinguished by the horizontal sync clock H_{SYNC}, the electronic device may store line data 1-1 and line data 1-2 related to the first line, in the first buffer 321 and the second buffer 322 respectively. In the time interval t2, the electronic device may store the line data 1-2 in the second buffer 322 and concurrently store the line data 2-1 in the first buffer 321.

In an arbitrary time interval distinguished by the designated clock, the electronic device may store at least part of the line data related to a different line, in the buffers. In FIG. 8, in a time interval tk distinguished by the horizontal sync clock H_{SYNC}, the electronic device may store line data k-1 in the first buffer 321 and store line data (k-1)-2 in the second buffer 322. For example, in tB, the electronic device may store line data B-1 in the first buffer 321 and store line data (B-1)-2 in the second buffer 322. In t(B+1) the electronic device may store line data k-2 in the second buffer 322. The first buffer 321 and the second buffer 322 may store the line data at different times. The delay of the first line may occur between the first buffer 321 and the second buffer 322.

The first ISP 260-1 and the second ISP 260-2 may be electrically connected to the first buffer 321 and the second buffer 322 respectively. The first ISP 260-1 and the first buffer 321 may process or store part of the frame data 810 related to the first interval. The second ISP 260-2 and the second buffer 322 may process or store part of the frame data 810 related to the second interval.

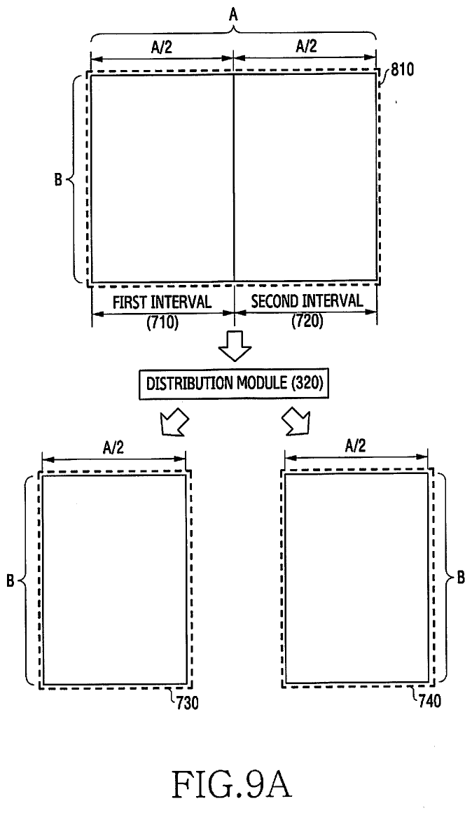

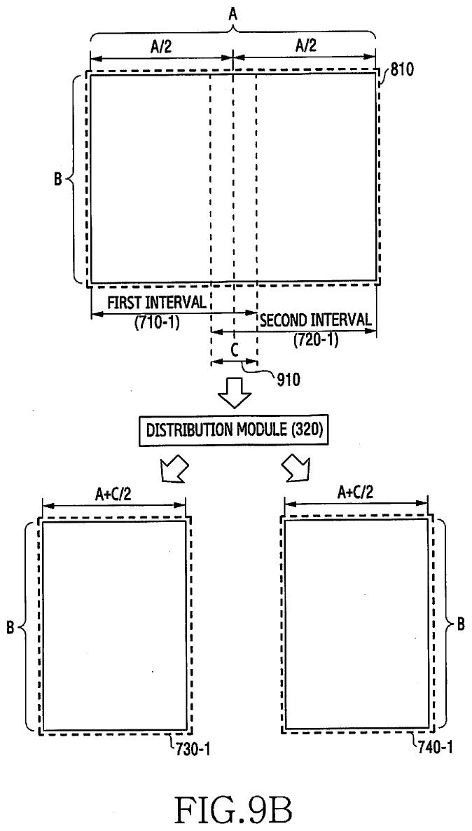

FIG. 9A illustrates segmenting frame data based on a distribution module in an electronic device according to an embodiment.

Referring to FIG. 9A, the intervals may not overlap each other in the horizontal line. For example, a first interval 710 and a second interval 720 each may include A/2 pixels (where A is an integer greater than or equal to 2) in the horizontal line including A pixels. If segmenting the frame data 810 or line data based on the first interval 710 and the second interval 720, the electronic device may segment the data based on lens shading correction (LSC), auto exposure/auto focus/auto white balance (3A) statics in the segmented boundaries.

Based on the distribution module, the electronic device may obtain first partial data 730 and second partial data 740 by segmenting the frame data 810 according to the first interval 710 and the second interval 720. The electronic device may store the first partial data 730 and the second partial data 740 in corresponding buffers (e.g., the first buffer 321 and the second buffer 322 as illustrated in FIG. 7 or FIG. 8), respectively.

FIG. 9B illustrates segmenting frame data based on a distribution module in an electronic device according to an embodiment.

Referring to FIG. 9B, the intervals may overlap each other in the horizontal line. For example, the first interval 710 and the second interval 720 both may include an overlapping interval 910 which is set based on the center of the frame data 810. For example, if the overlapping interval 910 includes designated C pixels (where C is an integer greater than or equal to 2), a first interval 710-1 and a second interval 720-1 which divide the A pixels in the horizontal line each may include A+C/2 pixels in the horizontal line. In this case, both of first partial data 730-1 and second partial data 740-1 acquired by the distribution module 320 may include the overlapping interval 910.

The overlapping interval 910 may be set to prevent discontinuous image processing or artifact caused by the intervals on boundaries of the partial data acquired from the frame data 810. The size of the overlapping interval 910 may be related to the system stability of the image processing.

The ISPs of the electronic device may perform the image processing based on the segmented partial data (e.g., the first partial data 730 and the second partial data 740).

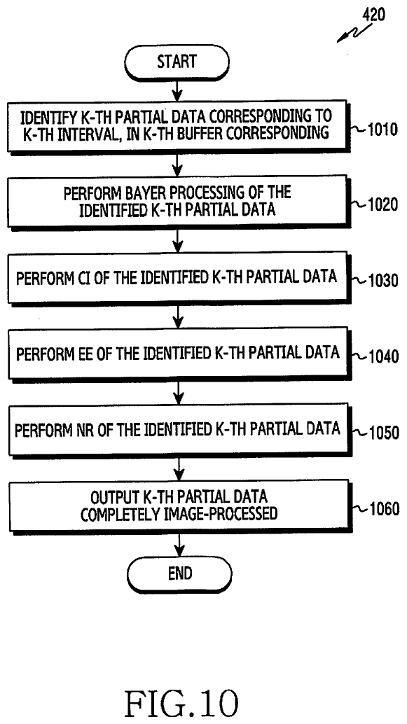

FIG. 10 illustrates a flowchart 420 of operations of ISPs in an electronic device according to an embodiment.

Referring to FIG. 10, in step 1010, the ISPs of the electronic device identify k-th partial data corresponding to a k-th interval, in a k-th buffer. The first ISP 260-1 through the N-th ISP 260-3 of FIG. 3 may identify partial data stored in the first buffer 321 through the N-th buffer 323 respectively.

In step 1020, the ISPs of the electronic device perform Bayer processing of the identified k-th partial data. The Bayer processing may include LSC, black level correction (BLC) and bad pixel correction (BPC) on the k-th partial data. The Bayer processing may be conducted based on raw frame data obtained from an image sensor.

In step 1030, the ISPs of the electronic device perform the CI of the identified k-th partial data. Based on the CI, the k-th partial data of the Bayer format based on the Bayer pattern of the pixels of the image sensor may be converted to the k-th partial data of RGB format or YUV format.

In step 1040, the ISPs of the electronic device perform the EE of the identified k-th partial data. Based on the EE, contrast difference on the boundaries of the subject may be enhanced in the k-th partial data.

In step 1050, the ISPs of the electronic device perform the NR of the identified k-th partial data. Based on the NR, noise of an analog signal in the pixel and a variance between the pixels due to the performance differences of the PDs of the pixel may be adjusted. Based on the NR, the pixel data of one of the pixels may be changed based on the pixel data of another one of the pixels.

In step 1060, the ISPs of the electronic device output the k-th partial data which is completely processed. For example, the first ISP 260-1 through the N-th ISP 260-3 of FIG. 3 may output the partial data completely processed, to the merging module 330. Since the frame data is processed by the ISPs in parallel, the ISPs each may operate based on a clock cycle which is longer than the clock used by the image sensor.

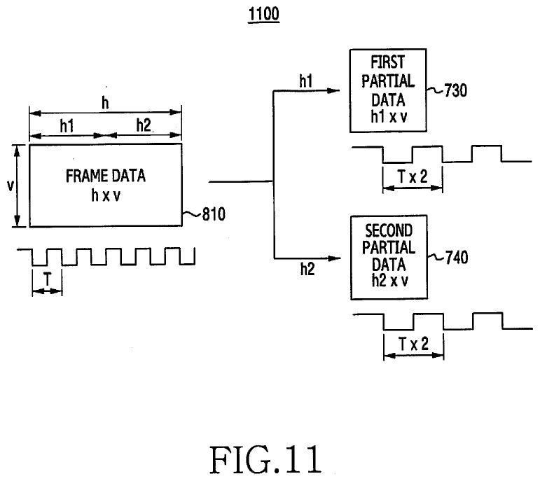

FIG. 11 illustrates a timing diagram 1100 of clocks used in different hardware components of an electronic device according to an embodiment. The electronic device using the timing diagram 1100 of FIG. 11 may correspond to the electronic device 101 or FIG. 1 or FIG. 3.

Referring to FIG. 11, the timing diagram of the electronic device including two ISPs is shown. The different hardware components (e.g., an image sensor, two ISPs) of the electronic device may operate based on a clock of different operating frequencies or cycles.

The image sensor of the electronic device may acquire frame data 810, based on the operating frequency of the electronic device having a designated cycle T. The operating frequency of the electronic device having the designated cycle T may correspond to the horizontal sync clock H_{SYNC}. For example, if a width of the frame data is h and a height is v, the electronic device may acquire the frame data of the size h×v on every v (v is an integer equal to or greater than 2) horizontal sync clocks.

The operating frequency of the two ISPs may correspond to ½ of the operating frequency of the electronic device including a single ISP. The cycle of the operating frequency of the two ISPs of the electronic device may be T×2 which is two times the cycle of the operating frequency of the image sensor. If the electronic device includes n ISPs (where n is an integer greater than or equal to 2), the cycle of the operating frequency of the n ISPs may be n times the cycle of the operating frequency of the image sensor. The electronic device may transmit first partial data 730 and second partial data 740 acquired by segmenting the frame data, to the two ISPs. The first partial data 730 may be in size h1×v, wherein the width h1 is smaller than h. The second partial data 740 may be also in size h2×v, wherein the width h2 is smaller than h. A sum of the width h1 of the first partial data 730 and the width h2 of the second partial data 740 may correspond to the width h of the frame data 810.

The two ISPs may process the first partial data 730 and the second partial data 740 based on the operating frequency of the cycle T×2. Since power consumption of the ISP is proportional to the operating frequency, the electronic device including the two ISPs may consume less power than the electronic device including the single ISP.

If processing the frame data based on a relatively high FPS, an electronic device including a plurality of ISPs may process the frame data without increasing the clock of the ISPs by the clock of the image sensor. For example, based on the ISP that processes a still image of 12M pixels (4000 horizontal pixels, at an aspect ratio 4:3) of 30 FPS, if the electronic device processes a high frame rate video of 1.2M pixels (1264 horizontal pixels, at an aspect ratio 4:3) of 900 FPS, the number of image data to process increases 30 times and the number of the horizontal pixels reduces about 3.1 times. Accordingly, the electronic device including the single ISP needs to increase the operating frequency of the ISP 10 times. However, an electronic device including five ISPs may process such a high frame rate video, merely by increasing the operating frequency of the ISP twice.

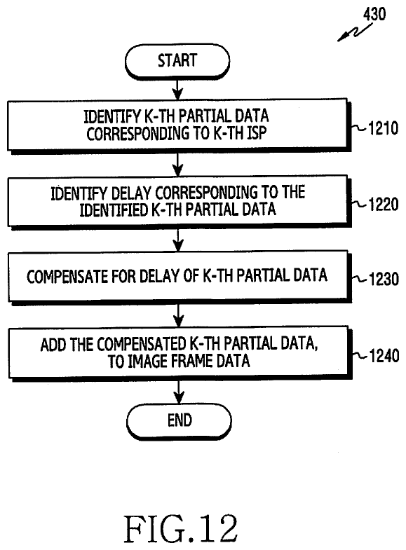

FIG. 12 illustrates a flowchart 430 of operations for storing image frame data based on a merging module and a storing module in an electronic device according to an embodiment. The electronic device of FIG. 12 may correspond to the electronic device 101 or FIG. 1 or FIG. 3. Operations of FIG. 12 may be performed by the merging module 330 and the storing module 340 of FIG. 3. Operations of FIG. 12 may be related to operation 430 of FIG. 4.

Referring to FIG. 12, in step 1210, the electronic device identifies k-th partial data corresponding to a k-th ISP. The k-th partial data identified by the electronic device may be data which is processed by the corresponding k-th ISP. For example, the merging module 330 of FIG. 3 may identify the processed data from the first ISP 260-1 through the N-th ISP 260-3.

In step 1220, the electronic device identifies a delay corresponding to the delayed k-th partial data. As described above with reference to FIG. 8, the electronic device may segment frame data to a plurality of buffers, based on delays corresponding to intervals respectively. As the frame data is segmented based on the delay, the ISPs may perform the image processing of the partial data of the frame data at different times based on a designated delay. Based on the designated delay, the ISPs may output an image processing result of line data related to a particular line at different times. The merging module of the electronic device may identify the delay corresponding to the ISPs.

In response to identifying the delay corresponding to the k-th partial data, the electronic device compensates for the identified delay of the k-th partial data in step 1230. The merging module of the electronic device may obtain every line data of the particular line which is outputted at the different times.

In step 1240, the electronic device adds the k-th partial data compensated, to the image frame data. Based on the storing module, the electronic device may obtain the frame data which is completely processed, based on the k-th partial data with the delay compensated.

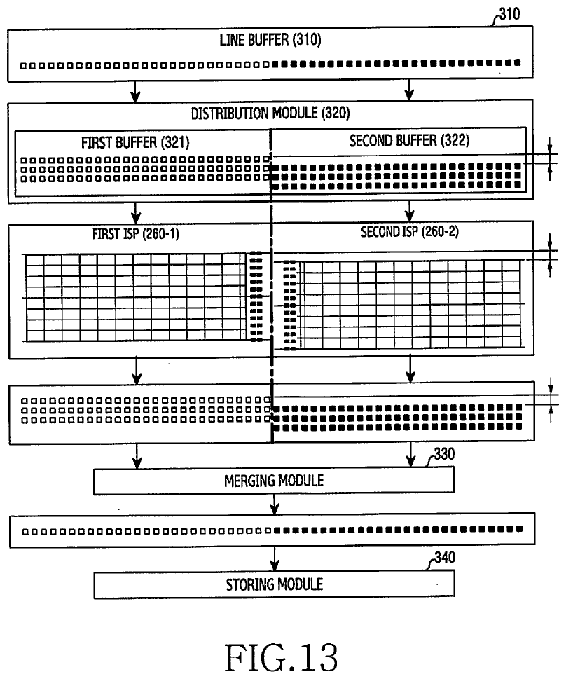

FIG. 13 illustrates processing frame data of an electronic device at a line buffer and a storing module according to an embodiment.

Referring to FIG. 13, the electronic device may store pixel data corresponding to pixels of any one line among pixels of an image sensor of the line buffer 310. Based on the distribution module 320, the electronic device may segment the pixel data stored in the line buffer 310 to a plurality of buffers corresponding to a plurality of ISPs respectively of the electronic device. Based on a plurality of intervals in the line, the electronic device may segment the pixel data stored in the line buffer 310. The electronic device may store the segmented pixel data in the buffers corresponding to the intervals. The electronic device may store the pixel data segmented based on a first interval and a second interval, in the first buffer 321 and the second buffer 322 corresponding to a first SIP 260-1 and a second SIP 260-2. The electronic device may store the pixel data segmented based on the first interval and the second interval, in the first buffer 321 and the second buffer 322 based on a designated delay.

The first SIP 260-1 and the second SIP 260-2 may perform image processing for the pixel data stored in the first buffer 321 and the second buffer 322. If the electronic device stores the pixel data in the first buffer 321 and the second buffer 322 based on the designated delay, the first SIP 260-1 and the second SIP 260-2 may output the pixel data processed based on the designated delay. The merging module 330 may compensate for different delays of the pixel data outputted from the first SIP 260-1 and the second SIP 260-2. The storing module 340 may obtain the processed frame data by merging the pixel data of the compensated delay. The storing module 340 may store the obtained frame data in a designated area of the memory.

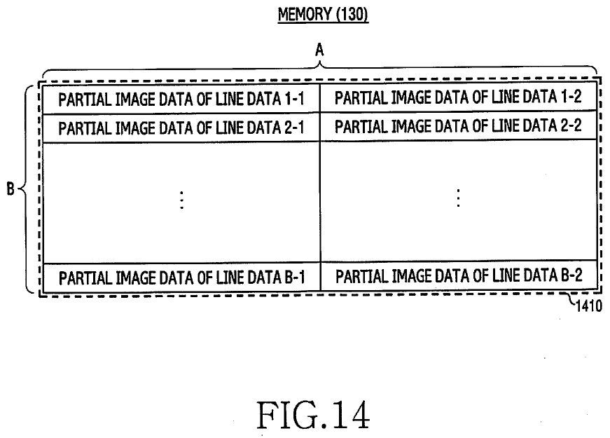

FIG. 14 illustrates storing image frame data in a memory of an electronic device according to an embodiment.

Referring to FIG. 14, the electronic device may store frame data processed by ISPs in a designated area of the memory 130, based on a storing module. The frame data structure is processed by the ISPs and stored in the designated area of the memory 130. If the image sensor includes A×B pixels (where A and B are integers greater than or equal to 2), the designated area of the memory 130 may have a size corresponding to the A×B pixels.

If image processing the frame data obtained from the image sensor based on two ISPs, the electronic device may segment the frame data based on two intervals of the line.

As stated earlier, partial data obtained by segmenting the frame data based on the two intervals may be processed by different ISPs.

The electronic device may merge and store the partial data processed by the different ISPs, in a designated area of the memory 130. In the memory 130, a start address for storing the partial data corresponding to the second interval may correspond to a next address of an end address for storing the partial data corresponding to the first interval. Although the ISPs output the pixel data for a particular line based on the designated delay, the pixel data may be stored based on positions of the pixels corresponding to the image sensor in the memory 130 by means of the delay compensation.

The frame data stored in the memory 130 may be processed by other hardware component of the electronic device (e.g., an AP such as the processor 120 of FIG. 3). The obtained frame data may be changed to an image file (e.g., JPEG format) or a video file (e.g., MPEG format) of a designated format.

The frame data is processed based on, but not limited to, the two ISPs and the two intervals of the line. The electronic device may include ISPs exceeding two in number, and may segment the frame data based on the intervals exceeding two in the line.

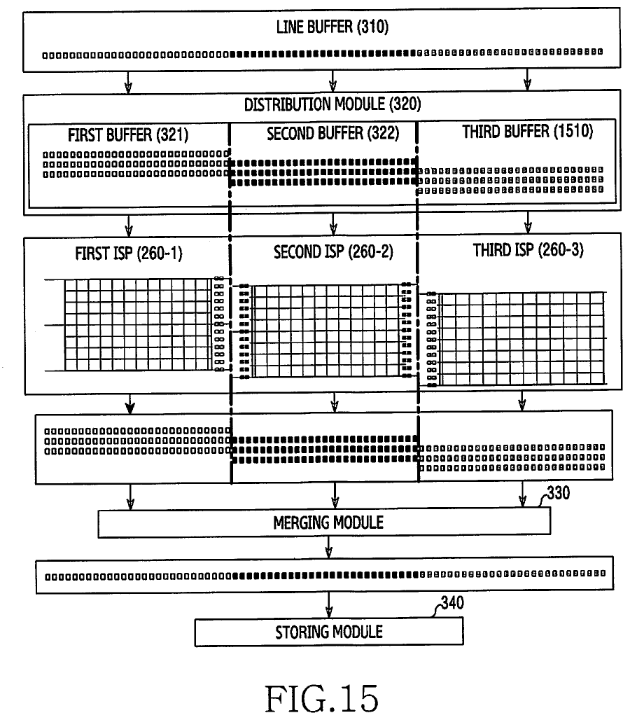

FIG. 15 illustrates processing image frame data based on three ISP in an electronic device according to an embodiment.

Referring to FIG. 15, the electronic device may obtain pixel data of any one of pixels of an image sensor on every designated first clock (e.g., pixel clock P_{CLK}). The obtained pixel data may be stored in the line buffer 310 on every first clock. The electronic device may obtain the pixel data from pixels of one of lines of the image sensor, and then sequentially access pixels of a next line of the line. The size of the line buffer 310 may correspond to the size of the pixel data of all the pixels of one of the lines of the image sensor.

Based on the distribution module 320, the electronic device may distribute the pixel data stored in the line buffer 310, to three buffers (i.e., a first buffer 321, a second buffer 322, and a third buffer 1510 of FIG. 15) corresponding to three ISPs (i.e., a first ISP 260-1, a second ISP 260-2, and a third ISP 260-3 of FIG. 15). Based on three intervals in the line, the electronic device may distribute the pixel data to the three buffers. The electronic device may distribute the pixel data to the three buffers, based on a designated delay. The designated delay may correspond to a time interval corresponding to the size of the interval of the line. The designated delay may correspond to a second clock (e.g., the horizontal sync clock H_{SYNC}) designated to transmit the pixel data from the line buffer 310 to any one of the three buffers.

The electronic device may perform image processing for partial data of the frame data segmented based on the three intervals and stored in the three buffers, based on the three ISPs. The three ISPs may operate based on a third clock (e.g., P_{CLK}/3 because the three ISP are used) which is longer than the first clock cycle. Accordingly, a sum of power consumed by the three ISPs may be lower than power consumed by a single ISP which operates based on the first clock.

The merging module 330 may merge the partial data processed by the three ISPs, based on the line of the image sensor. The merging module 330 may compensate for a delay applied by the line buffer 310 to distribute the pixel data to one of the three buffers. The merging module 330 may output the merged partial data corresponding to any one of the lines of the image sensor, on every second clock designated. The storing module 340 may store the merged partial data outputted from the merging module 330, in a memory (e.g., the memory 130 of FIG. 3) of the electronic device.

The electronic device may activate some of the ISPs, based on a processing time or a processing rate of the image processing operations. If the size of the frame data to process in real time is relatively small, the electronic device may process the frame data by activating only one of the ISPs. If the size of the frame data to process in real time is relatively great, the electronic device may process the frame data by activating all of the ISPs. The number of the ISPs activated by the electronic device may be determined based on at least one of the size or the FPS of the frame data. The electronic device may change the operating frequency of the ISP, based on the number of the activated ISPs.

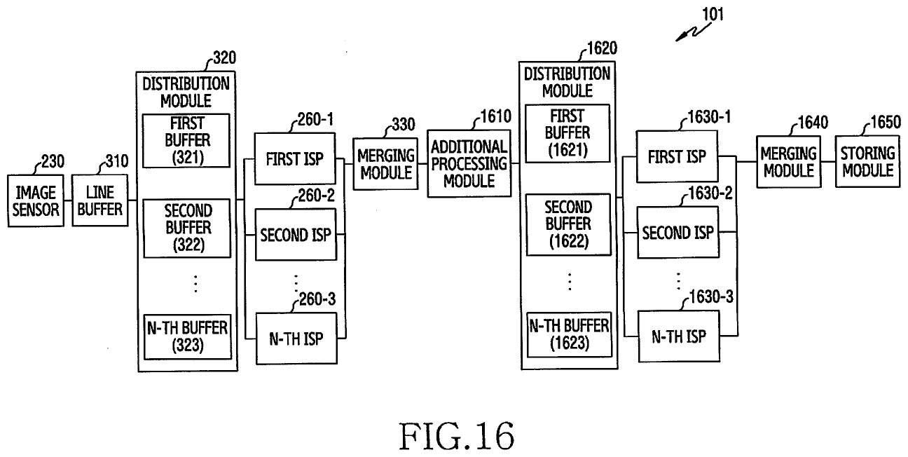

FIG. 16 illustrates a block diagram of an electronic device 101 according to an embodiment.

Referring to FIG. 16, the electronic device may process a first processing operation and a second processing operation which are distinguished based on one or more ISPs distinguished from each other, among a plurality of processing operations for processing frame data obtained from an image sensor 230. For example, the number of the ISPs for the first processing operation and the number of the ISPs for the second processing operation may be different from each other. As the number of the ISPs differs per processing operation, the number of intervals and buffers corresponding to the processing operation may differ.

A first ISP 260-1 through an N-th ISP 260-3 may be related to the first processing operation of the processing operations. Partial data processed by the first processing operation in the first ISP 260-1 through the N-th ISP 260-3 may be merged by a merging module 330. The merged frame data may be forwarded to a first ISP 1630-1 through an N-th ISP 1630-3 related to the second processing operation, based on a distribution module 1620 and buffers (i.e., a first buffer 1621 through an N-th buffer 1623). Partial data processed by the second processing operation in the first ISP 1630-1 through the N-th ISP 1630-3 may be merged and stored based on a merging module 1640 and a storing module 1650.

The merging module 1640 may operate in a similar manner to the merging module 330. For example, the merging module 1640 may be connected to some or all of the first ISP 1630-1 through the N-th ISP 1630-3. The merging module 1640 may merge pixel data processed at the ISPs based on a plurality of intervals of a line. As the merging module 1640 merges the pixels data received from the ISPs, frame data corresponding to the image frame data acquired at the image sensor 230 may be generated.

If the first processing operation requires more computations than the second processing operation, the number of the first ISP 260-1 through the N-th ISP 260-3 of the first processing operation may be greater than the number of the first ISP 1630-1 through the N-th ISP 1630-3 of the second processing operation. An additional processing module 1610 may perform a third processing operation relating to the image processing between the first processing operation and the second processing operation.

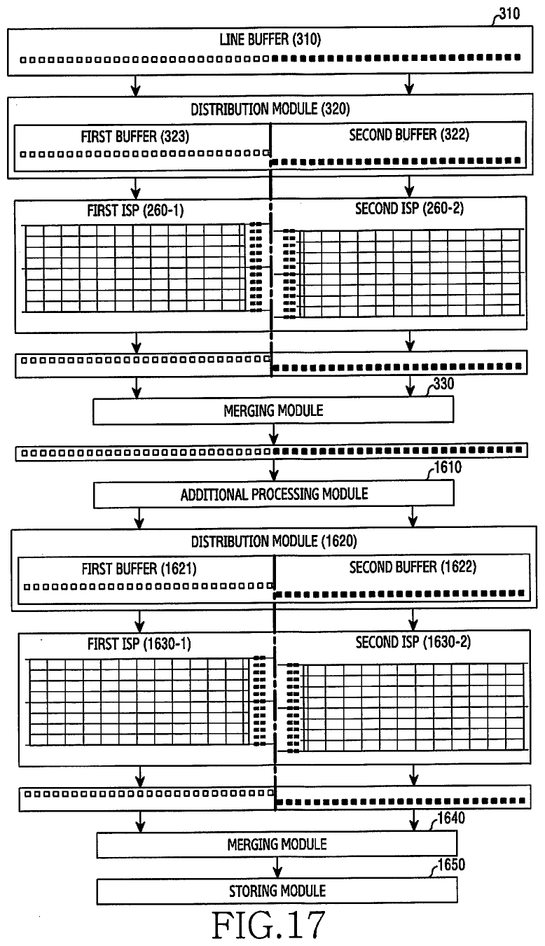

FIG. 17 illustrates frame data in an electronic device according to an embodiment.

Referring to FIG. 17, the electronic device may store pixel data corresponding to pixels of any one of lines of an image sensor, in a line buffer 310. Similar to FIG. 15, the electronic device may segment the pixel data stored in the line buffer 310, to buffers (i.e., the first buffer 321 and the second buffer 322). The electronic device may perform a first image processing operation related to the segmented pixel data, using ISPs (i.e., the first ISP 260-1 and the second ISP 260-2) corresponding to the buffers respectively. The electronic device may restore frame data by merging the pixel data passing through the first image processing operation of the ISPs, using the merging module 330.

The electronic device may perform another image processing operation (e.g., frame data scaling) which is distinguished from the first image processing operation, based on an additional processing module 1610. The electronic device may segment the frame data passing through the first image processing operation, based on the distribution module 1620. The segmented frame data may be stored in buffers (i.e., the first buffer 1621 and the second buffer 1622) related to a second image processing operation. The electronic device may perform image processing for the segmented frame data stored in the buffers (i.e., the first buffer 1621 and the second buffer 1622) related to the second image processing operation, using ISPs (i.e., the first ISP 1630-1 and the second ISP 1630-2) related to the second image processing operation. The electronic device may merge and store the segmented frame data passing through the second image processing operation, using the merging module 1640 and the storing module 1650.

The electronic device may segment the frame data of the image sensor to the partial data, based on the line buffer and the distribution module of the size corresponding to some of the lines of the image sensor. The segmented frame data may be processed in parallel by the plurality of the ISPs. The operating frequency of the ISPs may reduce from the operating frequency of the image sensor based on the number of the ISPs. As the operating frequency of the ISPs decreases, the power consumption of the ISPs may reduce.

An electronic device according to an embodiment may include an image sensor, an image sensor module including a line buffer configured to at least temporarily store image frame data obtained from the image sensor, on a line basis, a distribution module including a plurality of line buffers and configured to, while at least in part obtaining the image frame data using the image sensor, obtain line data which is part of the image frame data at least temporarily stored in the line buffer, transmit first partial data corresponding to a first designated interval of the line data to an image processing module which is electrically connected, and transmit second partial data corresponding to a second designated interval of the line data to another image processing module which is electrically connected, a first image processing module configured to perform image processing for the first partial data obtained through the distribution module, a second image processing module configured to perform image processing for the second partial data obtained through the distribution module, a merging module configured to generate merged line data by merging the first partial data processed at the first image processing module and the second partial data processed at the second image processing module, and a memory module configured to store the merged line data sequentially outputted from the merging module, as at least part of frame data corresponding to the image frame data.

At least one of the first interval or the second interval may be configured by segmenting a line of the image sensor by a designated length.

The first interval and the second interval may be configured to overlap at least in part in a line of the image sensor.

The distribution module may delay the second partial data corresponding to the second interval of the line data by a time interval corresponding to a size of the first interval of the line data, and transmits the delayed second partial data to the second image processing module.

Based on a designated time interval delay of the second interval of the line data inputted to the second image processing module, the merging module may merge the second interval processed by the second image processing module and the first interval processed by the first image processing module.

A first clock used by the first image processing module and the second image processing module to process the image may have a longer cycle than a second clock used by the image sensor module to output the image frame data.

According to an embodiment, an electronic device may include a plurality of photo diodes disposed based on a plurality of lines, a buffer configured to at least part of image frame data acquired at the photo diodes, and a processor configured to acquire an image based at least in part on first image data acquired by processing first partial data stored in the buffer using a first image signal processor (ISP) and second image data acquired by processing second partial data stored in the buffer using a second ISP, the first partial data and the second partial data corresponding to a first interval and a second interval respectively which are distinguished in the lines.

The electronic device may further include a memory operatively coupled with the first ISP and the second ISP, wherein, in the memory, a start address of storing the second image data may correspond to a next address of an end address of storing the first image data.

The electronic device may further include a distribution module configured to providing the first data and the second data to a first buffer corresponding to the first ISP and a second buffer corresponding to the second ISP respectively.

The distribution module may delay the second data by a time interval corresponding to a size of the first data and provide the delayed second data to the second buffer.

The electronic device may further include a merging module configured to merge the first image data and the second image data based on arrangement of first photo diodes and second photo diodes of a first line of the lines.

The merging module may merge the first image data and the second image data, based on a delay between transmission of the first data to the first ISP and transmission of the second data to the second ISP.

The buffer may have a size corresponding to all of photo diodes of any one of the lines.

The first ISP may be configured to process third partial data received through at least one photo diodes disposed adjacent to photo diodes of the first interval among photo diodes corresponding to the second interval which is next to the first interval of a first line of the lines.

The first ISP may be configured to identify the first partial data corresponding to the photo diodes corresponding to a designated interval of the lines, and acquire the first image data by processing the identified first partial data.

The second ISP may be configured to process the second partial data received through photo diodes corresponding to the second interval and fourth partial data received through at least one photo diode disposed adjacent to photo diodes of the second interval.

According to an embodiment, an electronic device may include an image sensor including a plurality of photo diodes disposed based on a plurality of lines, and a processor operatively coupled with the image sensor, wherein the processor is configured to store part corresponding to a first line of the lines, of image frame data obtained from the photo diodes, segment part of the stored image frame data into a plurality of partial data corresponding to a plurality of intervals of the first line, the intervals defined by distributing photo diodes of the first line of the photo diodes, perform image processing on the partial data, and acquire image frame data which is processed, by merging the partial data processed based on the intervals.

The processor may include a line buffer for storing part of the image frame data, corresponding to the first line.

The processor may include a plurality of image processing modules corresponding to the intervals respectively, wherein the image processing modules may perform image processing for the partial data corresponding to the intervals.

The image processing modules may operate based on a second clock signal which has a longer cycle than a first clock signal inputted to the image sensor.

As described above, an electronic device according to an embodiment, which includes a plurality of ISPs, may operate based on a relatively low operating frequency, to process frame data of a relatively high FPS or a considerable size. As the ISPs operate based on the low operating frequency, the electronic device may save more power than an electronic device including a single ISP.

The electronic device may process the frame data without a buffer of the size corresponding to the frame data, by segmenting the frame data on the line basis.

In the above-described embodiments of the disclosure, elements have been represented singular or plural form. It should be understood, however, that the singular or plural representations are selected according to the situations presented for the convenience of description, and the disclosure is not limited to the singular or plural constituent elements. Accordingly, the disclosure may be composed of a plurality of elements.

While the disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. An electronic device, comprising:
an image sensor;
an image sensor module including a line buffer configured to store image frame data obtained from the image sensor, on a line basis;
a distribution module including a plurality of line buffers and configured to:
while obtaining the image frame data using the image sensor, obtain line data that is part of the image frame data stored in the line buffer, and
transmit first partial data corresponding to a first designated interval of the line data, and second partial data corresponding to a second designated interval of the line data;
a first image processing module configured to perform image processing for the first partial data transmitted from the distribution module;
a second image processing module configured to perform image processing for the second partial data transmitted from the distribution module;
a merging module configured to generate merged line data by merging the first partial data processed at the first image processing module and the second partial data processed at the second image processing module; and
a memory module configured to store the merged line data sequentially output from the merging module as frame data corresponding to the image frame data.

2. The electronic device of claim 1, wherein at least one of the first interval or the second interval is configured by segmenting a line of the image sensor by a designated length.

3. The electronic device of claim 1, wherein the first interval and the second interval are configured to overlap at least in part in a line of the image sensor.

4. The electronic device of claim 1, wherein the distribution module is further configured to:
delay the second partial data corresponding to the second interval of the line data by a time interval corresponding to a size of the first interval of the line data, and
transmit the delayed second partial data to the second image processing module.

5. The electronic device of claim 1, wherein the merging module is further configured to, based on a designated time interval delay of the second interval of the line data inputted to the second image processing module, merge the second interval processed by the second image processing module and the first interval processed by the first image processing module.

6. The electronic device of claim 1, wherein a first clock used by the first image processing module and the second image processing module to process the image has a longer cycle than a second clock used by the image sensor module to output the image frame data.

7. An electronic device, comprising:
a plurality of photo diodes disposed based on a plurality of lines;
a buffer configured to at least part of image frame data acquired at the photo diodes;
a processor configured to acquire an image based on first image data acquired by processing first partial data stored in the buffer using a first image signal processor (ISP) and second image data acquired by processing second partial data stored in the buffer using a second ISP, wherein the first partial data and the second partial data correspond to a first interval and a second interval, respectively, which are distinguished in the lines.

8. The electronic device of claim 7, further comprising a memory operatively coupled with the first ISP and the second ISP,
wherein, in the memory, a start address for storing the second image data corresponds to an end address for storing the first image data.

9. The electronic device of claim 7, further comprising a distribution module configured to provide the first data and the second data to a first buffer corresponding to the first ISP and a second buffer corresponding to the second ISP, respectively.

10. The electronic device of claim 9, wherein the distribution module is further configured to:
delay the second data by a time interval corresponding to a size of the first data, and
provide the delayed second data to the second buffer.

11. The electronic device of claim 7, further comprising a merging module configured to merge the first image data and the second image data based on arrangement of first photo diodes and second photo diodes of a first line of the lines.

12. The electronic device of claim 11, wherein the merging module is further configured to merge the first image data and the second image data, based on a delay between transmission of the first data to the first ISP and transmission of the second data to the second ISP.

13. The electronic device of claim 7, wherein the buffer has a size corresponding to all of photo diodes of any one of the lines.

14. The electronic device of claim 7, wherein the first ISP is configured to process third partial data received through at least one photo diodes disposed adjacent to photo diodes of the first interval among photo diodes corresponding to the second interval that is next to the first interval of a first line of the lines.

15. The electronic device of claim 14, wherein the first ISP is further configured to:
identify the first partial data corresponding to the photo diodes corresponding to a designated interval of the lines, and
acquire the first image data by processing the identified first partial data.

16. The electronic device of claim 14, wherein the second ISP is configured to process the second partial data received through photo diodes corresponding to the second interval and fourth partial data received through at least one photo diode disposed adjacent to photo diodes of the second interval.

17. An electronic device, comprising:
an image sensor including a plurality of photo diodes disposed based on a plurality of lines; and
a processor operatively coupled with the image sensor,
wherein the processor is configured to:
store a part, corresponding to a first line of the lines, of image frame data obtained from the photo diodes,
segment a part of the stored image frame data into a plurality of partial data corresponding to a plurality of intervals of the first line, the intervals being defined by distributing photo diodes of the first line of the photo diodes,
perform image processing on the partial data, and
acquire image frame data that is processed by merging the partial data processed based on the intervals.

18. The electronic device of claim 17, wherein the processor comprises a line buffer for storing part of the image frame data corresponding to the first line.

19. The electronic device of claim 17, wherein the processor comprises a plurality of image processing modules respectively corresponding to the intervals, and
wherein the image processing modules perform image processing for the partial data corresponding to the intervals.

20. The electronic device of claim 19, wherein the image processing modules operate based on a second clock signal that has a longer cycle than a first clock signal input to the image sensor.
